(19) United States
(12) Patent Application Publication
(10) Pub. No.: US 2014/0311719 A1
(43) Pub. Date: Oct. 23, 2014

(54) MIXTURE FOR THERMAL ENERGY STORAGE AND DEVICE FOR HEAT STORAGE AND RELEASE USING SAID MIXTURE

(71) Applicant: OHIKIA S.R.L., Milano (IT)

(72) Inventors: Francesco Negrisolo, Sesto San Giovanni (IT); Maria-cristina Rosso, Torino (IT)

(73) Assignee: OHIKIA S.R.L., Milano (IT)

(21) Appl. No.: 14/357,593

(22) PCT Filed: Oct. 30, 2012
(86) PCT No.: PCT/EP2012/004531

§ 371 Date: May 12, 2014

(30) Foreign Application Priority Data
Nov. 11, 2011 (IT) MI2011A002050

(51) Int. Cl. C09K 5/10

(52) U.S. Cl. CPC C09K 5/10
USPC 165/144; 252/79

(57) ABSTRACT

Thermal energy storage mixture and heat storage/release device using same. The mixture including 45% by weight of compounds from a first class and 10% by weight of compounds from a second class. The first class having a melting temperature of at least 180° C. and a fusion enthalpy of at least 150 MJ/m³. The first class including β-lactose, myo-inositol, cellobiose, sodium acetate and sodium propionate, in which the at least one compound always includes β-lactose or sodium propionate or a mixture thereof. The second class having a melting temperature less than 180° C. The compound(s) of the second class being totally miscible, both in solid and liquid phase, with the compound(s) of the first class. The second class including organic compounds made of carbon, hydrogen and oxygen, of sodium salts of carboxylic acids and of potassium salts of carboxylic acids.

### FIELD OF APPLICATION

The present invention refers to a mixture for thermal energy storage and to a device for heat storage and release using such a mixture.

In particular the invention refers to a mixture of the aforementioned type with high capacity, in other words a composition capable of effectively storing thermal energy, and of releasing it, equally effectively, advantageously by means of a device capable of auto-regulating the heat release temperature, in other words the working temperature of the mixture.

### PRIOR ART

Materials, be they compounds or compositions, for storing thermal energy known in the prior art are classified into phase change materials (PCM), which exploit a phase transition to store and release thermal energy, and materials that have a high specific heat, which exploit a rise or drop in temperature to store and release thermal energy, respectively.

A material of the first type indicated above is also known as latent heat storage material, and it is able to store, maintaining a constant temperature, an amount of energy equal to the enthalpy variation linked to the phase transition.

Phase change materials have a storable energy density MJ/m³ greater even by one order of magnitude with respect to materials of the second type indicated above, which are also known as sensible heat storage materials, the most common of which are water, diathermic oil, molten salts.

The main drawback of sensible heat storage materials is their poor efficiency of storage of thermal energy, which involves the need to use large quantities thereof, and therefore to use very voluminous tanks for the heat exchange, not suitable for some applications as well as having a high cost.

Examples are boilers for hot water for sanitary use and thermostat systems with oil bath, where the heat produced by a conventional or recovery source is given up for use through a circuit equipped with a heat exchanger inside a device where the fluid to be heated is circulated.

Phase change materials used for storing thermal energy can consist of organic or inorganic mixtures, capable of operating at different temperatures depending on the requirements of the specific case. Mixtures of paraffin or polyethylene with different molecular weight used as materials for PCM systems have already been present on the market for a few years.

Document U.S. Pat. No. 6,627,106 describes a ternary mixture of inorganic salts for the storage of thermal energy in the form of latent heat due to phase transition.

The ternary mixture, based on salts of nitric acid, in particular based on magnesium nitrate hexahydrate, lithium nitrate and sodium or potassium nitrate, can work at a temperature comprised between 60° C. and 70° C. depending on the percentages of the components.

Although advantageous, a mixture of this type is not without drawbacks, including a non-negligible corrosive action towards many building materials usually employed in such a field, due to the presence of water and the high acidity of the mixture itself.

Mixtures of this type, moreover, display the tendency over time to separate into areas of different composition, with consequent variation in behaviour and reduction of the ability to store heat.

Document US 2008319126 describes an organic material for storing latent heat capable of operating within the temperature range 80° C.-160° C., comprising polyolefin waxes, in particular homopolymers of ethylene or propylene, or copolymers of propylene and ethylene, having a declared fusion enthalpy in the range 70-280 J/g.

This material, although advantageous, is also not without drawbacks, including a low density value, generally less than 1, and consequent poor density of storable energy, and low heat conductivity in solid state, which does not allow its use in large-sized devices, unless they have a particularly complex structure, since there is the need to limit the heat exchange distances in the PCM in solid state to the minimum.

In order to avoid the drawback of low heat conductivity, the prior art has provided micro-capsules containing a material for storing phase change heat.

For example, document DE 19654035 describes micro-capsules containing an organic PCM, dispersed in a heat transfer fluid medium.

Document US 2010087115 describes micro-capsules having a core comprising a phase change material with a high boiling point and a wall surrounding the core having a flame retardant agent.

Document US 2008157415 describes a composition and a method for making micro-capsules containing a phase change material through interfacial condensation polymerization.

Document EP 0722997 describes a further solution provided in the prior art, and in particular a composition for storing heat essentially comprising erythritol and an erythritol stabilizing agent.

Erythritol is a sugar with a melting temperature of 119° C. and a very high fusion enthalpy, equal to 501 MJ/m³, which has excellent characteristics for the storage of thermal energy.

Despite the aforementioned excellent characteristics, the use of erythritol as material for storing thermal energy is not very common due to its very high cost, which makes any device using exclusively erythritol or a high percentage of erythritol not cost-effective.

U.S. Pat. No. 5,785,885 discloses a heat storage material composition comprising at least one sugar alcohol selected from erythritol, mannitol and galactitol, and between 0.01 and 30% by weight of a salt having a solubility in anhydrous form of 20 g or less in 100 g of a saturated water solution at 25° C. and which is dispersed and maintained in the sugar alcohol as particles at a temperature of the heat storage material composition in a range of from 90 to 190° C. without being decomposed or dissolved.

U.S. Pat. No. 4,572,864 discloses a composite material for thermal energy storage comprising a solid state phase change material selected from the group consisting of pentaerythritol, pentaglycerine, neopentyl glycol, tetramethylol propane, monoaminopentaerythritol, diaminopentaerythritol, tris(hydroxymethyl)acetic acid, and mixtures thereof; these solid state phase change materials do not become liquid during use and are in contact with materials selected from the group consisting of metals, carbon siliceous, plastic, cellulosic, natural fiber, artificial fiber, concrete, gypsum, porous rock, and mixtures thereof.

The prior art describes further examples of mixtures for the storage of thermal energy, like for example mixtures based on calcium chloride hexahydrate CaCl₂.6H₂O, or based on potassium sulphate decahydrate Na₂SO₄.10H₂O which, although advantageous, have the drawback of being subject to a segregation of phases having different composition, in particular after many cycles of storage and release of thermal energy.

The aforementioned drawback can be reduced, but not completely eliminated, since it is caused by intrinsic properties of the mixture and, therefore, mixtures of this type have proven to be satisfactory in laboratory testing, but not suitable for use at industrial level, since they are not stable in their behaviour already after a few dozen cycles.

There are also mixtures that operate at particularly high temperatures, over 250° C. as lower limit, used in association with turbines and solar concentrators, useful in the case in which it is wished to maximise the production of electrical energy, but they cannot be used for common uses at lower temperatures.

Basically, up to now, the prior art still finds it impossible to provide a mixture for storing thermal energy that is economically advantageous, efficient and stable over time even after repeated storage-release cycles of thermal energy and that at the same time is able to release thermal energy in a narrow temperature range so as to maximise the use of thermal energy, as well as free of corrosive effects towards the materials commonly used in the sector of thermal energy storage.

### SUMMARY OF THE INVENTION

The technical problem underlying the present invention is that of providing a mixture for the storage of thermal energy having characteristics such as to overcome the quoted drawbacks with reference to the prior art, and in particular a mixture for thermal energy storage and release having a high specific energy density (fusion enthalpy per volume unit), having a low cost, which is able to keep the chemical-physical properties substantially unchanged even after a large number of cycles of thermal energy storage-release, in other words that is particularly stable over time, which is able to operate in a narrow temperature band comprised in the range 100° C.-200° C., which is not toxic or harmful to man or corrosive against the materials that are usually employed in the specific sector considered here.

The aforementioned technical problem is solved according to the invention by a mixture for the storage and release of thermal energy, comprising at least one compound selected from a first class consisting of compounds having a melting temperature and a fusion enthalpy equal to or higher than 180° C. and 150 MJ/m³, respectively, selected from β-lactose, myo-inositol, cellobiose, sodium acetate and sodium propionate, in which said at least one compound always comprises β-lactose or sodium propionate or a mixture thereof, in a total amount greater than 45% by weight with respect to the total weight of the mixture, and one or more compounds selected from a second class consisting of compounds having a melting temperature lower than 180° C., in a total amount greater than 10% by weight with respect to the total weight of the mixture, in which, in said mixture, the said one or more compounds of said second class are totally miscible, both in solid and liquid phase, with said at least one compound of said first class, said second class consisting of organic compounds made of carbon, hydrogen and oxygen, of sodium salts of carboxylic acids and of potassium salts of carboxylic acids.

Basically, according to the invention, a phase change mixture is provided that as a function of the composition (type and ratio between the amounts of the components) can operate at different temperatures or different temperature ranges, in any case always comprised between 100° C. and 200° C., which mixture comprises at least two compounds, i.e. at least one compound selected from the aforementioned first class, and at least one compound selected from the aforementioned second class, wherein the present mixture, in accordance with different embodiments, can in any case comprise more than one compound selected from each of the aforementioned first and second class.

Preferably, the compound or compounds of the second class are selected from glucose, xylitol, PEG 4000, erythritol, 1,2,3,4,5-pentanol and mannitol.

Advantageously, the compound or compounds of the present mixture belonging to the aforementioned first class constitute(s) the main component for the absorption and release of thermal energy (heat), whereas the compound or compounds belonging to the aforementioned second class make(s) it possible to vary the melting temperature of the present mixture according to needs, said mixture therefore being able to work at a predetermined temperature value or temperature range comprised between 100° C. and 200° C., without significantly reducing the phase change enthalpy of the mixture itself and without the occurrence of undesired phase segregation phenomena, thanks to the chemical affinity of the components and the thermal stability thereof at the working temperature of the mixture.

In accordance with a variant embodiment of the invention, the present mixture also comprises, up to a maximum of 30% by weight with respect to the total weight of the mixture, one or more compounds selected from a third class consisting of water and organic compounds made of carbon, hydrogen and oxygen, having boiling temperature higher than 70° C., being totally miscible, in the aforementioned mixture, with said one or more compounds of said first and second class in liquid phase, being chemically stable over time at the working temperature or within the working temperature range set for the present mixture, and in particular being chemically stable, such as not to irreversibly modify its/their molecular structure by reaction with the other compounds constituting the mixture, up to the highest temperature limit at which the present mixture can work, equal to 200° C.

Basically, the aforementioned third class consists of highly polar compounds, having a high chemical affinity towards the components of the present mixture belonging to said first and second class. These third class compounds can be foreseen to increase the degree of homogeneity and uniformity, of both the liquid and the solid phase, of the mixture according to the invention.

By compounds having chemical affinity we mean compounds having chemical-physical properties such as to allow, particularly but not exclusively and at least within certain borderline compositions, a homogeneous mixing thereof.

Preferably, the compound or compounds of the aforementioned third class are selected from water, ethanol, glycerol, ethylene glycol, propylene glycol, PEG 200, PEG 300 to PEG 1000, where PEG means polyethylene glycol.

In accordance with the invention, an amount equal to or lower than 7% by weight with respect to the total weight of the present mixture, of said compound(s) belonging to said third class, makes the temperature of heat storage and release of the mixture itself constant over time, for a given composition of the mixture, while an amount greater than 7% by weight with respect to the total weight of the mixture makes it possible, in accordance with the invention, to trigger a self-regulation process of the temperature of heat storage and release of the mixture, in a desired temperature range, as will become clearer hereafter.

In accordance with a further variant embodiment of the invention, the present mixture, both in the formulation comprising one or more compounds of said first class and of said second class, and in the formulation additionally comprising one or more compounds of said third class, includes, in an amount comprised between 1% and 10% by weight with respect to the total weight of the mixture, carbon powder consisting of particles having size equal to, or lower than, 1 millimeter.

Carbon powder having the aforementioned size has a large specific surface and is useful for increasing the conductivity of the mixture.

In particular, the large specific surface of the carbon particles allows a high surface interaction with the remaining compounds of the present mixture, promoting a homogeneous dispersion of the carbon particles in the mixture, particularly in solid phase.

Advantageously, the substantially homogeneous dispersion of the carbon powder in the mixture according to the invention, in the various compositions described, together with the similar apparent density of the carbon powder and the other compounds of the mixture, makes it possible to prevent a separation into areas with a marked difference in conductivity.

Therefore, in accordance with the invention, the aforementioned carbon powder avoids the formation, in the present mixture, of areas having a considerable difference in heat conductivity, in other words it avoids the formation of some areas with high heat conductivity and other areas with low heat conductivity that would not be suitable for use in the management of the heat flows.

Basically, in accordance with the invention, the present mixture, in the various aforementioned compositions, advantageously has a density greater than or equal to 1.35 kg/m³, preferably higher than 1.45 kg/m³, more preferably higher than 1.5 kg/m³.

The high density value brings about, in the mixture according to the invention, a high value of the amount of the storable energy per volume unit (energy density).

In accordance with a further aspect of the invention, a device is provided for thermal energy storage and release, for the use of the present mixture in the formulation according to claims 5, 8 and 9, i.e. in a formulation comprising, in addition to the compounds of said first and second class, also one or more compounds of said third class, irrespective of whether or not the aforementioned carbon powder is present.

Advantageously, the present device makes it possible to optimise the working temperature range of the mixture for storing and releasing heat, as a function of the temperature of the medium with which the mixture itself carries out the heat exchange.

The device according to the invention essentially comprises a first tank for containing a phase change thermal energy storage and release mixture of the aforementioned type, first means of heat exchange, active on the aforementioned first tank, preferably inside it, a second tank for containing at least one portion of the mixture, the aforementioned portion being obtained by partial evaporation of the mixture in the first tank, a first conduit extending between respective head portions of said first tank and of said second tank, a non-return valve active in said first conduit, second means of heat exchange active on said second tank, a second conduit extending between respective bottom portions of said second tank and of said first tank, and an elbow-shaped syphon housed in said second conduit and active between said second tank and said first tank.

Basically, the present device is a closed circuit that exploits the vapour pressure difference between the components of the mixture according to the invention belonging to the first class and to the second class with respect to the component or components of the third class present in the mixture itself, as well as the chemical affinity that the same components constituting the mixture have, particularly in the condensed phases, in order to optimise the working temperature range of the mixture as a function of the temperature of the medium with which the mixture exchanges thermal energy, in other words of the fluid used for the heat exchange.

In the present device there is in practice a unidirectional fluid communication from the first tank to the second tank, through the first conduit and by means of the non-return valve housed in it, and a unidirectional fluid communication from the second tank to the first tank, through the second conduit and by means of the syphon housed in it, thanks to which it is possible to carry out an adjustment of the working temperature of the mixture, exploiting changes in the composition induced by the characteristics of the device itself and of the mixture itself, and by the temperature of the fluid used for the heat exchange.

Further features and advantages will become clearer from the description of some example embodiments of a mixture and of a device for thermal energy storage and release according to the invention, made hereafter with reference to the attached drawings, provided for illustrating and not limiting purposes.

### BRIEF DESCRIPTION OF THE FIGURES

FIG. 1 shows a series of calorimetric curves, obtained through differential scanning calorimetry DSC with thermal gradient equal to 1° C./min, of some examples of compounds belonging to a first class of compounds that can be used in a mixture for thermal energy storage according to the present invention;

FIG. 2 shows a series of calorimetric curves, obtained through differential scanning calorimetry DSC with thermal gradient equal to 1° C./min, of some examples of compounds belonging to a second class of compounds that can be used, in combination with one or more compounds of the first class, in a mixture for thermal energy storage according to the present invention;

FIG. 3 shows a series of calorimetric curves, obtained through differential scanning calorimetry DSC with thermal gradient equal to 1° C./min, of some example embodiments of a mixture for phase change thermal energy storage in accordance with the present invention;

FIG. 4 shows the variation of enthalpy of the example embodiments of the mixture of FIG. 3, plus two further examples of variation of enthalpy of 1 m³ of a mixture according to a further embodiment of the invention, in which the different working temperature ranges determined by different compositions of the mixture are highlighted;

FIG. 5 shows the variation of thermal conductivity as a function of the amount of graphite in an example embodiment of a phase change mixture for the storage of energy in accordance with the invention, having, expressed in percentage by weight, the composition: 8.0% glycerol, 15.0% glucose, 77.0% β-lactose, in which as the amount of graphite varies the ratios between the three components are kept constant;

FIG. 6 schematically shows a partial section view of a device for the storage of thermal energy, particularly for the use of a composition for storing and releasing thermal energy in accordance with the present invention.

### DETAILED DESCRIPTION OF THE INVENTION

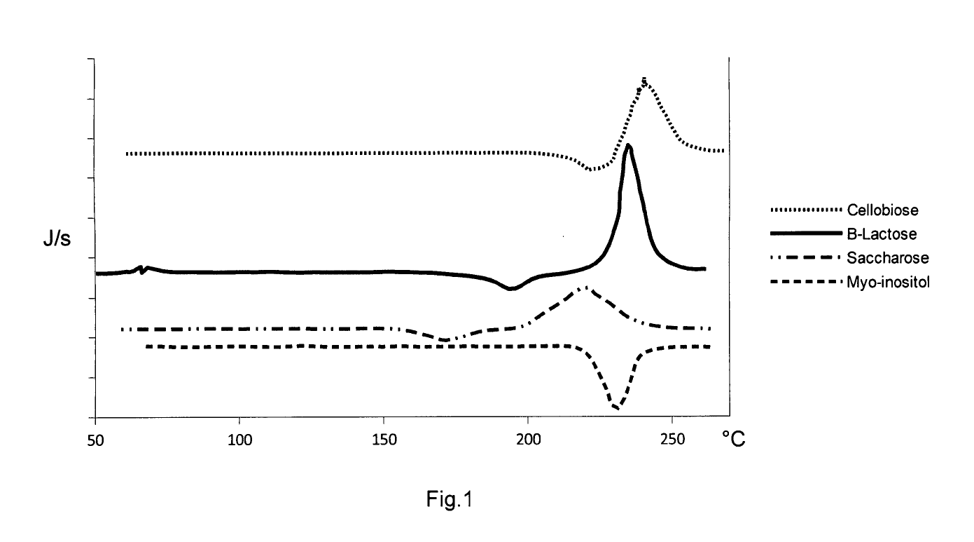

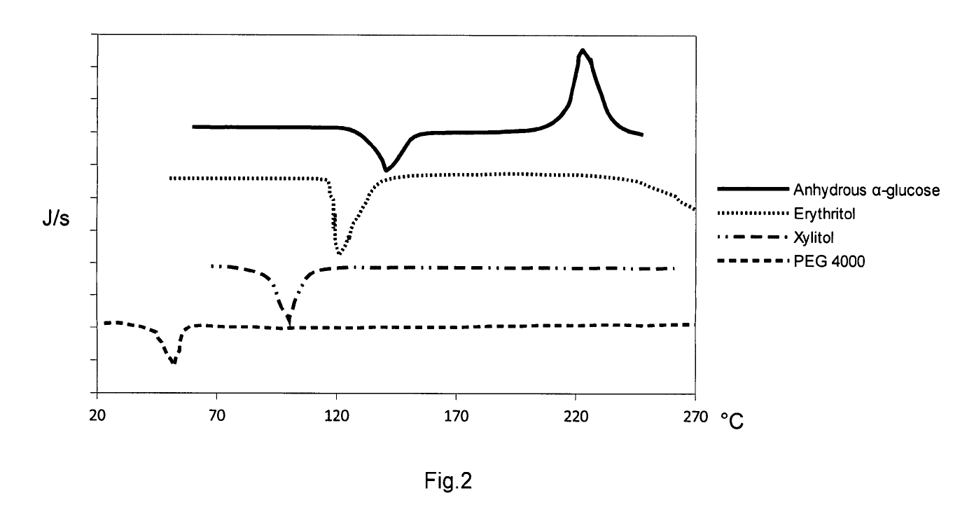

With reference to FIGS. 1 and 2, a series of calorimetric curves of some examples of compounds belonging to respective classes, first and second, are illustrated, which compounds can be used in making a phase change mixture (PCM), for storing and releasing thermal energy in accordance with the present invention.

In particular, FIG. 1 refers to the differential scanning calorimetric analysis of four compounds belonging to the aforementioned first class (cellobiose, β-lactose, saccharose and myo-inositol), which consists of organic compounds made of carbon, hydrogen and oxygen, of sodium salts of carboxylic acids and of potassium salts of carboxylic acids, having a melting temperature equal to or higher than 180° C., and a fusion enthalpy equal to or higher than 150 MJ/m³.

FIG. 2 refers to the differential scanning calorimetric analysis of four compounds belonging to the aforementioned second class (anhydrous α-glucose, erythritol, xylitol, PEG 4000), which consists of organic compounds made of carbon, hydrogen and oxygen, of sodium salts of carboxylic acids and of potassium salts of carboxylic acids, having a melting temperature below 180° C.

In accordance with first embodiments of the present invention, in fact, the present mixture comprises compounds belonging to the first and to the second class, at least one compound per class, the overall amount of which is, for the compound or compounds of the first class, equal to or higher than 45% by weight with respect to the total weight of the mixture, and for the compound or compounds of the second class not less than 10% by weight with respect to the total weight of the mixture, in which the compound or compounds of the second class, in the present mixture, are totally miscible, both in solid and liquid phase, with the compounds of the first class in the same mixture.

The characteristics of the compounds shown in FIGS. 1 and 2, and those of some further examples, are indicated in respective tables, 1 and 2 given below.

TABLE 1
examples of compounds of the first class - class A

| Compound | Melting T | ΔH of fusion | Density |
|---|---|---|---|
| Saccharose | 185° C. | 187 MJ/m³ | 1587 kg/m³ |
| β-lactose | 210° C. | 354 MJ/m³ | 1590 kg/m³ |
| myo-inositol | 225° C. | 466 MJ/m³ | 1752 kg/m³ |
| Cellobiose | 239° C. | 159 MJ/m³ | 1760 kg/m³ |
| Sodium acetate | 324° C. | 281 MJ/m³ | 1528 kg/m³ |
| Sodium propionate | 289° C. | 184 MJ/m³ | 1333 kg/m³ |

The compounds of the first class, in the mixture according to the present invention, constitute the main components for the absorption and release of thermal energy.

TABLE 2
examples of compounds of the second class - class B

| Compound | Melting T | ΔH of fusion | Density |
|---|---|---|---|
| Glucose | 146° C. | 286 MJ/m³ | 1587 kg/m³ |
| xylitol | 94° C. | 373 MJ/m³ | 1520 kg/m³ |
| PEG 4000 | 58° C. | 212 MJ/m³ | 1128 kg/m³ |
| Erythritol | 119° C. | 501 MJ/m³ | 1480 kg/m³ |
| 1,2,3,4,5-pentanol | 102° C. | 376 MJ/m³ | 1525 kg/m³ |
| Mannitol | 164° C. | 503 MJ/m³ | 1490 kg/m³ |

The compounds of the second class that have a melting temperature lower than that of the compounds of the first class make it possible, based on their percentage present in the mixture according to the present invention, to vary the melting temperature of the mixture within the temperature range 100° C.-200° C., without significantly reducing the variation in enthalpy linked to the phase change of the mixture itself that occurs after the storage or release of thermal energy.

In accordance with the invention, indeed, the present mixture stores and releases thermal energy in a temperature range comprised within the range 100° C.-200° C., determined by the type, and by the ratio between the amounts, of the components of the first and second class that are present in the mixture, according to specific needs.

Examples of a mixture comprising compounds of the first and second class, with relevant working temperature ranges are indicated in table 3 given below.

TABLE 3

| Composition | Working T | ΔH of fusion | Density |
|---|---|---|---|
| 80% β-Lactose-20% | 175-180° C. | 321 MJ/m³ | 1490 Kg/m³ |
| PEG4000 | | | |
| 30% β-Lactose-50% Xylitol- | 196-205° C. | 326 MJ/m³ | 1503 kg/m³ |
| 20% Sodium propionate | | | |

In accordance with second embodiments of the invention, the present mixture also comprises one or more compounds belonging to a third class consisting of water and organic compounds made of carbon, hydrogen and oxygen, having boiling temperature higher than 70° C., in a total amount lower than or equal to 30% by weight with respect to the total weight of the mixture, totally miscible in liquid phase with the compounds of the mixture belonging to the first and second class, and stable at the working temperature of the mixture.

Basically, at temperatures below 200° C., the compound or compounds of the third class, in the present mixture, must not react irreversibly with a change in molecular structure with the other components of the mixture.

Examples of compounds of the third class, with some typical characteristics, are given below in table 4.

TABLE 4
examples of compounds of the third class - class C

| Compound | Melting T | ΔH of fusion | Density |
|---|---|---|---|
| Water | 100° C. | 333 MJ/m³ | 1000 kg/m³ |
| Ethanol | 78.4° C. | 84 MJ/m³ | 789 kg/m³ |
| Glycerol | 280° C. (dec.) | 248 MJ/m³ | 1260 kg/m³ |
| Ethylene glycol | 197° C. | 177 MJ/m³ | 1110 kg/m³ |
| Propylene glycol | 188° C. | 109 MJ/m³ | 1036 kg/m³ |
| PEG 200 | 185° C. | 305 MJ/m³ | 1123 kg/m³ |
| PEG 300- . . . 1000 | | | |

In accordance with the invention, an amount lower than or equal to 7% by weight with respect to the total weight of the mixture, of the compound or compounds of the third class, makes it possible to obtain a temperature of thermal energy storage and release that is practically constant over time, whereas a greater amount makes it possible to trigger a self-regulation process of the temperature of heat storage and release, as will become clearer hereafter.

Preferred examples of mixtures comprising compounds of the first, second and third class, and relevant characteristics are given in the following table 5.

TABLE 5
examples of mixtures comprising a component for each
one of the classes (first, second and third).

| | | | ΔH of | |
|---|---|---|---|---|
| Mixture | Composition | Working T | fusion | Density |
| 1 | 48% β-Lactose-26% Glucose | 110-130° C. | 309 MJ/m³ | 1503 kg/m³ |
| | 26% Glycerol | | | |
| 2 | 75% β-Lactose-17% Glucose | 130-145° C. | 334 MJ/m³ | 1563 kg/m³ |
| | 8% Glycerol | | | |
| 3 | 80% β-Lactose + 15% | 167-171° C. | 324 MJ/m³ | 1498 kg/m³ |
| | PEG4000 | | | |
| | 5% Glycerol | | | |
| 4 | 70% sodium propionate + 10% | 178-210° C. | 204 MJ/m³ | 1311 kg/m³ |
| | PEG3000 + 10% Glycerol | | | |

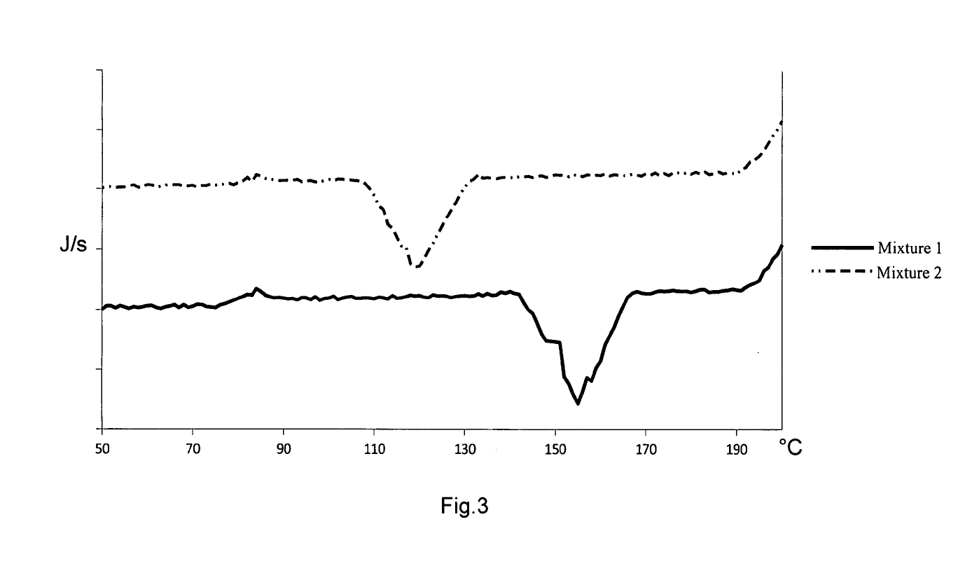

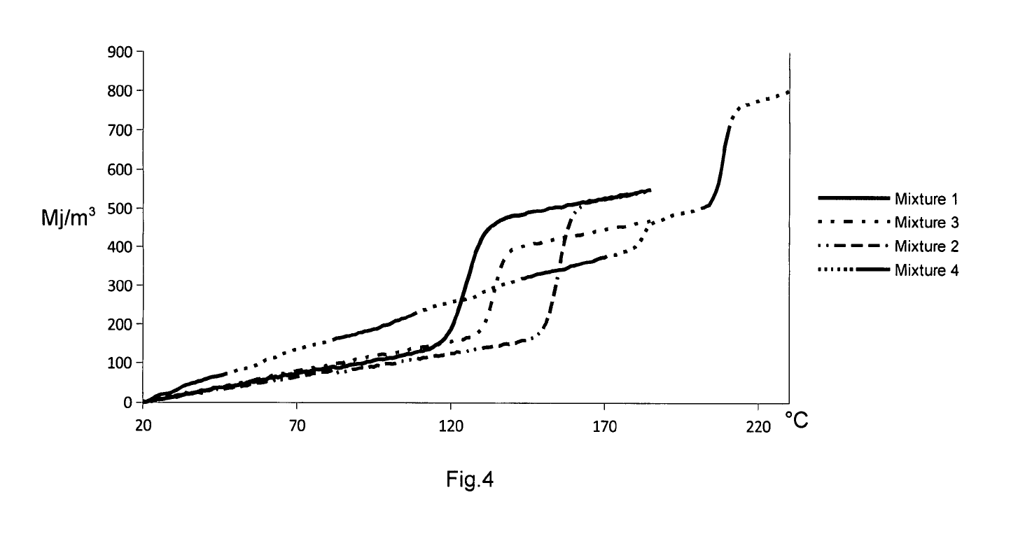

FIG. 3 shows the calorimetric curves obtained through differential scanning analysis of the mixtures 1 and 2 indicated in table 5, whereas FIG. 4 shows the variation in enthalpy of the mixtures indicated in table 5 per 1 m³ of mixture.

In accordance with further embodiments of the invention, the present mixture also comprises a further component, specifically carbon powder consisting of particles having size equal to or lower than 1 mm, in an amount comprised between 1% and 10% by weight with respect to the total weight of the mixture.

Carbon powder of the aforementioned type has a large specific surface and a high thermal conductivity, and it can be provided in the present mixture both in the formulation comprising one or more compounds of the third class, and in the formulation without compounds belonging to the third class.

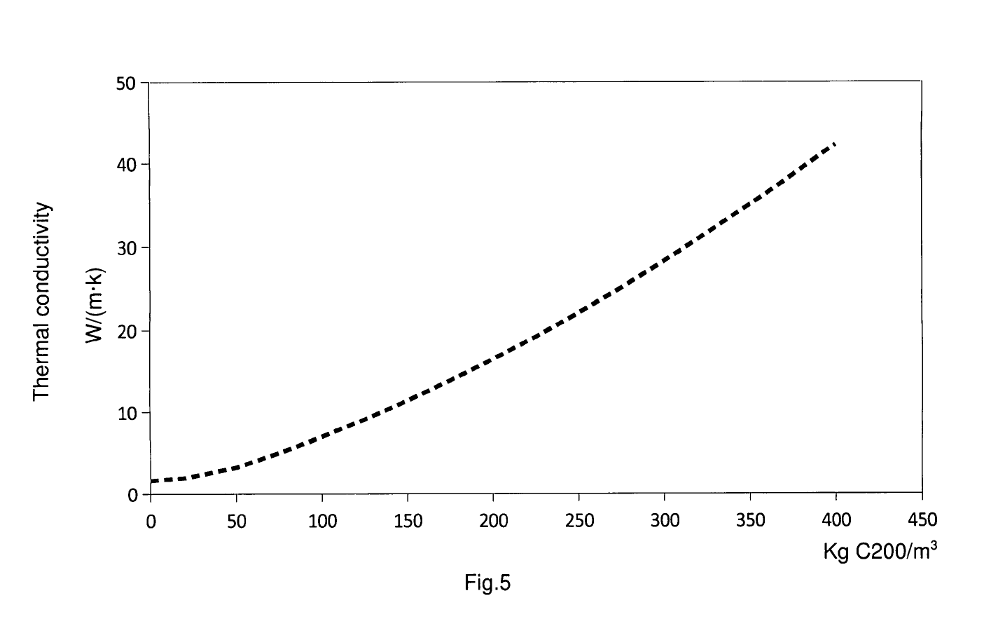

FIG. 5 shows the variation of the thermal conductivity as a function of the amount of graphite of an example of mixture according to the present invention, particularly a composition comprising, as a compound of the first class, β-lactose in an amount by weight equal to 77%, as a compound of the second class, glucose in an amount by weight equal to 15% and as a compound of the third class, glycerol in an amount by weight equal to 8%, where, as the amount of graphite varies, the ratios between the three components are kept constant.

Based on tests carried out by the Applicant, the aforementioned behaviour of the thermal conductivity can be regarded as as a general characteristic of the compositions according to the present invention comprising graphite powder as considered above.

For mixtures according to any one of claims 5, 8 and 9, i.e. for mixtures comprising one or more compounds of the third class, in a total amount greater than 7% by weight with respect to the total weight of the mixture, and, as considered above, less than 30% by weight with respect to the total weight of the mixture, the present invention provides a device that makes it possible to optimise the working temperature range of the mixture for thermal energy storage and release, particularly as a function of the temperature of the fluid medium with which the mixture itself carries out the heat exchange.

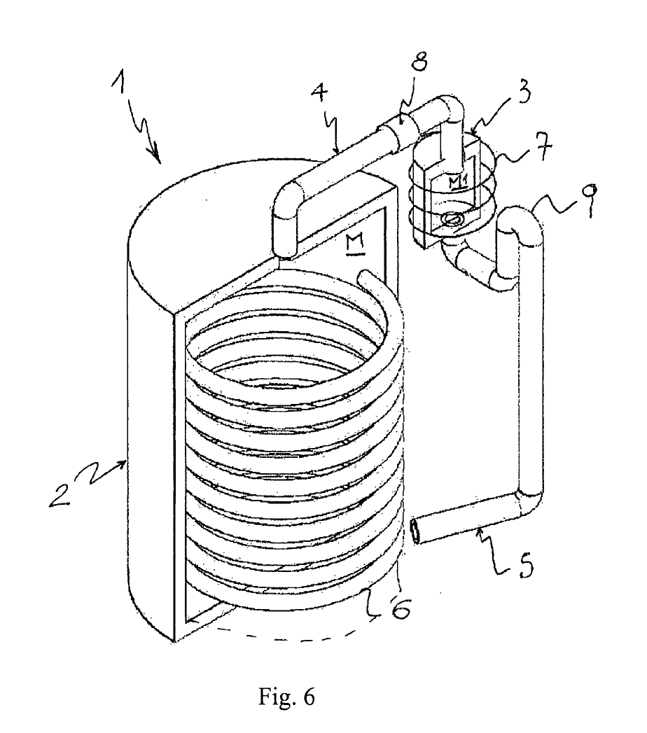

Such a device, illustrated in FIG. 6 where it is generally indicated with 1, essentially comprises a first tank 2 for containing a predetermined amount of a phase change mixture for thermal energy storage and release of the type considered above, indicated with M, a second tank 3 for containing at least part of the mixture, particularly for containing a low boiling point fraction of the phase change mixture, indicated with M1, which tanks are connected together at respective head portions through a first conduit 4, and at respective bottom portions by a second conduit 5.

The device 1 also comprises first means of heat exchange, wholly indicated with 6, acting on the first tank 2 and in particular arranged inside the tank 2 and suitable for exchanging heat with the mixture M contained in it, which means, in the example of FIG. 6, are represented by a coil inside the first tank.

The device 1 also comprises second means of heat exchange, wholly indicated with 7, acting on the second tank 3 and in particular suitable for exchanging heat with the aforementioned low boiling point fraction of the mixture inside the second tank 3, which means, in the example of FIG. 6, are represented by a coil outside the second tank, and which alternatively can comprise plate and/or mantle heat-exchangers preferably external to the second tank 3.

Furthermore, the device 1 comprises a non-return valve 8, housed in, and acting on, the first conduit 4, and an elbow-shaped syphon 9, housed in the second conduit 5 and active between the second tank 3 and the first tank 2.

Basically, the present device is a closed circuit that exploits the vapour pressure difference between the component or components of the mixture belonging to the first class and to the second class with respect to the component or components of the third class that are present in the mixture itself, as well as the chemical affinity that the same components constituting the mixture have in the condensed phases, in order to optimise the working temperature range of the mixture as a function of the temperature of the medium with which the mixture exchanges thermal energy.

In the present device there is, in practice, a unidirectional fluid communication from the head of the first tank 2 to the head of the second tank 3, through the first conduit 4 and by means of the non-return valve 8 housed in it, and a unidirectional fluid communication from the bottom of the second tank 3 to the bottom of the first tank 2 through the second conduit 5 and by means of the syphon 9 housed in it.

In this way a PCM storage system comprising the device and the mixture according to the present invention described above, is able to carry out an adjustment of the working temperature of the mixture, exploiting changes in the composition of the mixture M, induced by the characteristics of the device, by the differential evaporation of the components of the mixture, and by the temperature of the fluid with which the heat exchange occurs through the first means of heat exchange (external fluid).

In detail, the operating cycle comprises the following steps:
A step of storage of thermal energy at the minimum working temperature.

In this step, heat coming from an external heat exchange fluid, through the first means of heat exchange, is transferred to the PCM mixture contained in the first tank and having a predetermined composition, with a consequent increase in the temperature of the mixture up to a value corresponding to the solid-liquid transition temperature typical of the mixture.

Thereafter, further heat supplied to the mixture modifies the ratio between the amount of solid and liquid in the first tank.
A step in which the working temperature is increased.

In the case in which the external fluid has a higher temperature with respect to the minimum temperature necessary to completely melt the PCM mixture, there occurs evaporation of a certain amount of the component or components of the mixture belonging to the third class indicated above, in other words the low boiling point component or components of the mixture.

The evaporation brings about an over-pressure in the device, in particular in the upper or head portion of the first tank, and consequently the generated vapours reach the second tank through the first conduit and the non-return valve housed in it.

Thereafter, the vapours in the second tank are condensed through the second means of heat exchange, for example through a heat dispersion system using a coil.

In this way, the condensed vapours, thus in liquid phase, remain trapped in the second tank thanks to the presence of the syphon that does not allow them to come out.

The evaporation of a certain amount of the component or components of the mixture belonging to the third class as described above, causes a change in the composition of the mixture contained in the first tank, in particular it brings about a decrease in the amount of the component or components having a lower melting temperature, with a consequent change, specifically with an increase, of the phase transition temperature of the portion of mixture inside the first tank.

In particular, the solid-liquid phase transition temperature of the mixture M increases up to a maximum value, determined by the temperature of the external fluid.
A heat release step

Thanks to the raising of the phase transition temperature described above, the mixture, in the present device, releases heat to the external fluid at a temperature that is higher on average with respect to the temperature at which the heat has been stored that corresponds to the temperature which is typical of the mixture initially contained in the first tank (starting composition or mixture entirely in solid state).

The possibility of exploiting heat at a higher temperature makes it possible to increase the efficiency of systems connected downstream of the device, for example an electric energy generator operating with ORC cycle.

During the heat release step, the liquid formed in the second tank by the condensation of the vapour of the low boiling point component or components of the mixture, is held, thanks to the syphon, in the second tank itself, while the valve active in the first conduit allows to keep stable the pressure above the liquid inside the first tank.
Restoring the initial conditions.

Once the release of heat to the external fluid has been completed, with consequent solidification of the PCM mixture, the pressure in the first tank decreases, triggering the syphon and allowing the liquid contained in the second tank to reach the first tank, through the second conduit.

At this point in the PCM mixture an area with lower melting temperature with respect to the initial one of the mixture is formed, which will operate as a first core for liquefying the PCM mixture and for absorbing heat from the external fluid.
Restarting the cycle.

Once the external fluid has reached the temperature that triggers melting in the area of the mixture with a high concentration of component(s) of the third class, the mixture once again starts to absorb heat and, thanks to the chemical affinity of the various components of the mixture and the convective motion of the liquid phase, the composition of the entire PCM mixture will tend towards homogeneity as the solid fraction lacking in components of the third class passes into liquid phase.

The advantages of the present invention, which have clearly appeared from the above description, can be summarised by remarking that a mixture is provided for storing and releasing thermal energy that is particularly cost-effective, efficient and stable over time even after numerous work cycles, which makes it possible to maximise the use of thermal energy, which is not harmful or toxic to human beings, and which does not have substantial characteristics of corrosiveness towards the materials usually employed in devices for storing thermal energy, generally consisting of tanks, heat exchangers, sensors etc, for example metallic materials such as carbon and stainless steels, aluminium, copper, brass and the like.

The mixture according to the invention, in fact, comprises low-cost components (the current cost of 1 kg of mixture is less than 3 Euros), which are stable both individually and in mixture, particularly in the absence of oxygen and in the predetermined working temperature range for a specific composition of the mixture, which do not modify their characteristics over time and do not display phenomena of phase segregation if suitably mixed at the preparation step of the mixture itself, and which are defined as non-cancerogenous, non-mutagenic and non-toxic agents in the Italian legislative decree of 3 Feb. 1997 no. 52 and subsequent modifications implementing the directive 92/32/EEC concerning the classification, packaging and labelling of dangerous substances.

A further advantage of the invention lies in the structural and functional simplicity of the present device, which makes it possible to maximise the use of thermal energy and which has proved particularly cost-effective.

Advantageously, the present device and the present mixture for the storage and release of thermal energy can be used in a domestic environment as well as in industrial processes of various kinds in which there is a need to manage heat, including the processes for producing electrical energy or for recovering waste heat.

A person skilled in the art can bring numerous modifications to the mixture and the device for the storage of thermal energy according to the invention, in the embodiments illustrated and described, in order to satisfy contingent and specific requirements, all of which are in any case covered by the extent of protection of the invention, as defined by the claims given hereafter.

1-13. (canceled)

14. A mixture for thermal energy storage and release comprising at least one compound selected from a first class consisting of compounds having a melting temperature and a fusion enthalpy equal to or higher than 180° C. and 150 MJ/m³, respectively, selected from β-lactose, myo-inositol, cellobiose, sodium acetate and sodium propionate, wherein said at least one compound always comprises β-lactose or sodium propionate or a mixture thereof in a total amount greater than 45% by weight with respect to the total weight of the mixture, and
one or more compounds selected from a second class consisting of compounds having a melting temperature lower than 180° C., in a total amount greater than 10% by weight with respect to the total weight of the mixture, wherein in said mixture said one or more compounds of said second class are totally miscible, both in solid and liquid phase, with said at least one compound of said first class, said second class consisting of organic compounds made of carbon, hydrogen and oxygen, of sodium salts of carboxylic acids and of potassium salts of carboxylic acids.

15. The mixture according to claim 14, wherein said one or more compounds of said second class is/are selected from glucose, xylitol, PEG 4000, erythritol, 1,2,3,4,5-pentanol and mannitol.

16. The mixture according to claim 14, further comprising, in an amount equal to or lower than 30% by weight with respect to the total weight of the mixture, one or more polar compounds selected from a third class of compounds consisting of water and organic compounds made of carbon, hydrogen and oxygen having a boiling temperature higher than 70° C., said one or more compounds selected from said third class being totally miscible in liquid phase, in said mixture, with said one or more compounds of said first and second class.

17. The mixture according to claim 16, wherein said one or more compounds of said second class is/are selected from glucose, xylitol, PEG 4000, erythritol, 1,2,3,4,5-pentanol and mannitol.

18. The mixture according to claim 16, wherein said one or more compounds of said third class is/are selected from water, ethanol, glycerol, ethylene glycol, propylene glycol, PEG 200, PEG 300 to PEG 1000.

19. The mixture according to claim 18, wherein said one or more compounds of said second class is/are selected from glucose, xylitol, PEG 4000, erythritol, 1,2,3,4,5-pentanol and mannitol.

20. The mixture according to claim 18, containing said one or more compounds of said third class in an amount greater than 7% by weight with respect to the total weight of the mixture.

21. The mixture according to claim 19, containing said one or more compounds of said third class in an amount greater than 7% by weight with respect to the total weight of the mixture.

22. The mixture according to claim 14, further comprising, in an amount comprised between 1% and 10% by weight with respect to the total weight of the mixture, carbon powder comprising particles having size equal to, or lower than, 1 millimeter.

23. The mixture according to claim 19, further comprising, in an amount comprised between 1% and 10% by weight with respect to the total weight of the mixture, carbon powder comprising particles having size equal to, or lower than, 1 millimeter.

24. The mixture according to claim 14, having a density equal to, or higher than, 1.35 kg/m³, preferably higher than 1.45 kg/m³, more preferably higher than 1.5 kg/m³.

25. The mixture according to claim 21, further comprising, in an amount comprised between 1% and 10% by weight with respect to the total weight of the mixture, carbon powder comprising particles having size equal to, or lower than, 1 millimeter.

26. The mixture according to claim 21, having a density equal to, or higher than, 1.35 kg/m³, preferably higher than 1.45 kg/m³, more preferably higher than 1.5 kg/m³.

27. A device for thermal energy storage and release comprising a first tank for containing a phase change mixture for thermal energy storage and release according to claim 20, first means of heat exchange active on said first tank, a second tank for containing at least one portion of said mixture, a first conduit extending between respective head portions of said first tank and of said second tank, a non-return valve active in said first conduit, second means of heat exchange active on said second tank, a second conduit extending between respective bottom portions of said second tank and of said first tank, and an elbow-shaped syphon housed in said second conduit.

28. The device according to claim 27, wherein said first means of heat exchange are at least partially internal to said first tank.

29. The device according to claim 28, wherein said first means of heat exchange comprise a coil internal to said first tank.

30. The device according to claim 27, wherein said second means of heat exchange comprise coils and/or plate and/or mantle heat-exchangers external to said second tank.

31. The device according to claim 30, wherein said first means of heat exchange comprise a coil internal to said first tank.
